(19) United States
(12) Patent Application Publication
(10) Pub. No.: US 2008/0129422 A1
(43) Pub. Date: Jun. 5, 2008

(54) Tunable or Re-Configurable Dielectric Resonator Filter

(76) Inventors: Neil McNeill Alford, London (GB); Peter Krastev Petrov, London (GB); Andrey Borisovich Kozyrev, St. Petersberg (RU); Vladimir Nikolaevich Keis, St. Petersberg (RU); Oleg Yureivich Buslov, St. Petersberg (RU)

Correspondence Address: MINTZ LEVIN COHN FERRIS GLOVSKY & POPEO;ATTN: PATENT INTAKE CUSTOMER NO. 35437, ONE FINANCIAL CENTER, BOSTON, MA, 02111, US

(21) Appl. No.: 11/792,180

(22) PCT Filed: Dec. 1, 2005
(86) PCT No.: PCT/GB05/50227

§ 371 Date: Jun. 1, 2007

(30) Foreign Application Priority Data
Dec. 1, 2004 (GB) 0426350.5

(51) Int. Cl. H01P 1/208

(52) U.S. Cl. 333/209

(57) ABSTRACT

A dielectric resonator filter having at least two poles for filtering a frequency band from an input frequency spectrum, which filter comprises (i) a body (2a, 2b) formed of electrically conductive material, which body (2a, 2b) defines a cavity (13) therein; (ii) a dielectric resonator element (1) enclosed in said cavity (13), (iii) a deformable member (6) located outside said cavity, and (iv) a metal member (4) located within said cavity (13) that is connected to said deformable member (6), the arrangement being such that, in use, said deformable member (6) is deformable to move said metal member (4) toward and/or away from said dielectric resonator element (1) to effect adjustment of a said frequency band.

### FIELD OF THE INVENTION

The present invention relates to a tunable or re-configurable dielectric resonator filter, to a filter comprising a plurality of such filters, to an electronic device comprising the filter, to a method of filtering different frequency bands from an input frequency spectrum, to a method of tuning a dielectric resonator filter, and to a piezoelectrically tunable microwave filter.

### DESCRIPTION OF THE PRIOR ART

In current microwave communication technology dielectric resonators (DRs) are key elements for filters, low phase noise oscillators and frequency standards. DRs possess resonator quality factors (Q) comparable to cavity resonators, strong linearity at high power levels, weak temperature coefficients, high mechanical stability and small size.

A dielectric resonator is a device in which a piece of high dielectric constant (>1) material, commonly known as a puck, is placed within a conducting enclosure that has an input and an output for an electrical signal at microwave frequencies (typically between about 300 MHz and 3 GHz). The puck is often supported away from the walls of the enclosure by a hollow tube of low dielectric constant material. Application of the electrical signal causes the DR to resonate at a number of different modes. Each mode has different resonant frequency at which most of the electromagnetic energy is stored within the DR; the arrangement of the electric and magnetic fields of each mode is also different. Which mode has the lowest resonant frequency (the fundamental mode) is determined by the dimensions of the puck and by the external boundary conditions. The external boundary conditions may include tuning screws, for example, that project into the enclosure for perturbing the electromagnetic field around the puck, thereby changing the fundamental mode with the lowest resonant frequency.

There are a very large number of different modes that can be excited in a DR. Generally these modes are classified according to the direction of the electric and magnetic fields relative to the axes of a co-ordinate system. Most often cylindrical pucks are used and enclosed in a cylindrical cavity. Accordingly cylindrical co-ordinates can be used (with the longitudinal axis of the puck lying on the z-axis) to distinguish the different modes into four broad categories: Transverse Electric (TE_{npg}), Transverse Magnetic (TE_{npg}), and Hybrid modes, designated variously as Hybrid Electric HE_{npg} (or HEM_{npg}) and EH_{npg}, where n and p are integers that describe the standing wave pattern in the azimuthal and radial directions respectively. It should be noted that some authors have used the terms HE and HEM to refer to the same resonance mode. For the TE and TM modes n=0 as there are no electric or magnetic fields in the axial (z) direction. The third index g is used to denote the number of half-wavelength variations in the axial direction. In a DR g is often written as δ (or is omitted entirely) to denote that the dielectric has a height less than one-half wavelength.

The hybrid modes are so-called because non-vanishing axial (z) components of the electric and/or magnetic fields are present.

Microwave filters have been made that use DRs. The filter function is achieved by using more than one DR and coupling the energy between them (e.g. with irises or slots between each cavity). Each DR in the filter is tuned to a different resonant frequency. With two or more such DRs, each tuned to a different but closely spaced frequency, a filter-like function can be obtained. The number of resonant frequencies used to obtain the filter function is known in the art as the number of “poles”. As explained below, it is not always the case that the number of poles is equal to the number of DRs used in the filter.

In particular, it is possible to excite a number of degenerate modes (usually two) with identical resonant frequencies in one DR. The independence between these degenerate modes can be destroyed and the energy between them mutually coupled by perturbing the rotational symmetry of the structure, for example using a coupling screw. The resonant frequency of each degenerate mode can then be independently tuned (e.g. with an appropriately aligned tuning screw respectively) to separate the two resonant frequencies and provide a filter function. Thus in this case the number of poles of the filter is two, but only one DR is present. DRs that employ two modes are known in the art as “dual mode” DRs. It is possible to couple the energy between more than one dual mode DR to obtain e.g. a four-pole, six pole, etc. filter. The more poles that are used the larger the pass band of the filter can be.

The tuning of DR filters is a very difficult task. Despite the very high manufacturing standards available today, the shapes, sizes and arrangement of inter alia: the enclosure, the puck, the support for the puck, and if needed, the shape and size of the coupling slot(s); are never ideal. For example, the puck is never a perfect cylinder (or whatever other shape is used). As explained above, the resonant (or centre) frequency of each DR is dependent on these shapes, sizes and positions (assuming materials are kept the same). Therefore each filter that is manufactured must be tuned to ensure that the filter has the desired characteristics e.g. bandwidth, insertion loss and return loss. All of the poles of the filter must be tuned correctly to achieve this. However, the interaction between the dimensions of each component, the electromagnetic fields, and the coupling between each pole is extremely complicated. Accordingly, skilled operatives are employed to tune each filter using one or more tuning screw that projects into the cavity of each pole. As the number of poles increases the tuning problem becomes even harder. The operatives appear to use intuition to achieve the tuning on each filter, since the solution is different each time. Once the filter has been tuned by an operative the tuning screws are often fixed in position (e.g. using Araldite®) to prevent loss of the correct configuration for that particular filter.

An example of such a filter is shown in EP 1 041 663. In particular, it discloses a four pole filter comprising two dielectric resonators each operated in the dual mode. Each dielectric resonator has pair of tuning screws for tuning the resonance frequency of each of two orthogonal HEM₁₁₁ resonant modes respectively. The coupling between these modes is provided by a third tuning screw located midway between the first two at an angle 45° thereto. The two dielectric resonators are coupled by cruciform shape irises. Such a filter is only adjustable post-manufacture with extreme difficulty.

In many applications that employ DR microwave filters, some element of re-configurability is desirable. In other words, it would be useful if the pass band of the filter could be adjusted post manufacture whilst maintaining the other properties of the filter (e.g. insertion loss, return loss, filter shape—Chebyshev, elliptic, etc.) substantially the same. It would also be desirable if the re-configuration could be activated remotely i.e. without the need for an operative to perform the re-configuration manually, and for the re-configuration to take place quickly.

For example, in communications applications (e.g. mobile telephone, satellite) it would be desirable if the pass band of a microwave filter (e.g. in a base station) could be shifted to permit greater capacity. For example a mobile telecommunications system operating according to the Universal Mobile Telecommunications System (UMTS) may use a 5 MHz uplink channel and a 5 MHz downlink channel in the 1.9 GHz to 2.1 GHz part of the spectrum. Microwave filters are used to extract these channels from the frequency spectrum. If either of the channels becomes saturated it would be useful if the infrastructure could be re-configured to switch to a new 5 MHz channel. This would necessitate inter alia manual adjustment of the DR microwave filter in the base station to filter the new channel from the spectrum.

The present invention is based upon the insight by the applicant that it is possible to re-configure dielectric resonator microwave filters remotely, quickly and easily, substantially without change in the electrical characteristics of the filter.

We have now developed a filter based on dielectric resonators which employs one or more devices coupled and arranged in a way to provide small size, low weight and cost effective microwave filters with electrical tuning of the frequency band.

According to the present invention there is provided a dielectric resonator filter having at least two poles for filtering a frequency band from an input frequency spectrum, which filter comprises (i) a body formed of electrically conductive material, which body defines a cavity therein; (ii) a dielectric resonator element enclosed in said cavity, (iii) a deformable member located outside said cavity, and (iv) a metal member located within said cavity that is connected to said deformable member, the arrangement being such that, in use, said deformable member is deformable to move said metal member toward and/or away from said dielectric resonator element to effect adjustment of said frequency band. In use the filter may be a microwave filter for operation in the microwave portion of the spectrum e.g. between 2 and 3 GHz. The present invention provides:—
i. The possibility to decrease the size and weight of a filter by using dual mode resonators;
ii. The possibility to control the type of the filter response;
iii. Cost effectiveness and speed of manufacture—the present invention uses only one perturbing member for tuning purposes;
iv. Following manufacture the filter is quickly re-configurable (over e.g. about 10 frequency bands at 2 GHz) to operate in a different frequency band substantially without loss of filter characteristics.

According to another aspect of the present invention there is provided a dielectric resonator filter having at least two poles for filtering a frequency band from an input frequency spectrum, which filter comprises (i) a body formed of electrically conductive material, which body defines a cavity therein; (ii) a dielectric resonator element enclosed in said cavity, and (iii) a perturbing member, the arrangement being such that, in use, said dielectric resonator element resonates in a dual mode in which there are at least two modes having a respective degenerate resonant frequency, and said perturbing member is moveable into and out of said cavity so as to adjust simultaneously the spacing between said at least two degenerate resonant frequencies and the coupling of energy between said at least two modes.

The invention also provides a tunable filter based on at least one dielectric resonator which is piezoelectrically controlled and in which the fundamental is the dual generated HEM₁₁ mode.

The invention further provides an improved filter comprising at least one dielectric resonator in which there is a perturbing member to control filter response type (elliptic or a Chebyshev type characteristics) and a deformable member to adjust the filter frequency band, for example, by adjustment of a voltage.

The fundamental mode of the dielectric resonator may be the dual generated HEM₁₁ mode.

The dielectric dual mode degeneration is preferably controlled by a field perturbing member and to control the dielectric resonator dual mode degeneration, only one perturbing member which is moveable into and out of the cavity is used which may be located at angles α=(n·90°+45°), (where n=0, 1, 2, 3) in reference of the input connector plane. When located at an angle α=(n·90°+45°), (where n=0 or 1) the perturbing member provides feedback between the input/output loops, which results in an elliptic characteristic of the filter response. When the perturbing member is located at an angle α=(n·90°+45°), (where n=2 or 3), the filter has a Chebyshev type response.

Preferably, movement of said deformable member effects a shift of said frequency band from a lower to a higher frequency band, or vice versa. One advantage of the present invention is that one or more filter characteristic of said filter remains substantially unaffected by said adjustment.

Advantageously, said cavity, in which resonance takes place, has the same dimensions following said adjustment. This helps to make the filter more robust and more reliable.

Preferably, said deformable element is deformable in response to a signal, whereby said adjustment may be made remotely from said filter. This is a previously unrealized advantage: it is now possible to adjust the frequency band without the need for manual tuning of the filter to regain the previous filter characteristics. In one embodiment said deformable element is deformable upon application of a voltage.

Advantageously, in use said deformable element is able to effect an overall movement of said metal member from a point about 200 μm away from said dielectric resonator element to a point substantially in abutment with part of said dielectric resonator element. In one embodiment this relatively small movement is able to effect movement of the filtered frequency band by 400 MHz at 2 GHz, substantially without degrading the filter response.

Preferably, said deformable member is connected to said metal member via an arm, which arm is slidable in use through an aperture in said body.

Advantageously, said deformable member comprises a piezoelectric bimorph.

Preferably, said piezoelectric bimorph is held substantially fixed relative to said body by a top cap. This helps to ensure that any deformation is translated into movement of the metal plate.

Advantageously, said filter is configured such that in use, said at least two poles are provided by a dual mode in which at least two degenerate resonant frequencies are supported on one dielectric resonator element. This helps to reduce the physical size of the filter and enables a filter function to be achieved using only one dielectric resonator element if desired.

Preferably, said filter further comprises a perturbing member that is moveable into an out of said cavity for simultaneously adjusting the energy coupled between said at least two degenerate resonant frequencies and the spacing between the resonant frequencies thereof. This is a surprising effect with significant advantages: for example the speed of tuning of the filter at the end of the manufacturing process can be increased as only one variable need by adjusted. Furthermore the filter characteristics remain substantially constant even when the frequency band is adjusted as described above.

Advantageously, said perturbing member is positioned in a part of said cavity in which at each point the amplitude of the respective electric field due to said at least two degenerate modes is substantially the same. This helps the perturbing member to adjust the at least two resonant degenerate frequencies simultaneously. In one embodiment there is only one perturbing member per dielectric resonator element. Preferably, said perturbing member is located substantially at an angles α=(n·90°+45°) where n=0, 1, 2, 3 in reference of the input connector plane or line. The line may defined by the axis of an input microstrip for example with the angle α being measure in an anti-clockwise sense from said line to an axis of said perturbing member.

Advantageously, said perturbing member may be located at an angle α=(n·90°+45°) where n=0 or 1 to provide an elliptic response of said filter.

Preferably, said perturbing member may be located at an angle α=(n·90°+45°), (where n=2 or 3) to provide a Chebyshev response of said filter.

Advantageously, said perturbing member is positioned to substantially maintain symmetry in plan view between an input and an output to said dielectric resonator element.

Preferably, said perturbing member comprises an adjustable screw for movement into and out of said cavity.

Preferably, said filter further comprises a dielectric substrate defining a lower limit of said cavity. In one embodiment the dielectric substrate extends to the walls of the cavity.

Advantageously, said dielectric substrate comprises a metallized side and a dielectric side, said dielectric resonator element supported on said dielectric side

Preferably, the filter further comprises a pair of microstrip lines providing an input and an output to said filter.

Advantageously, said pair of microstrip lines is substantially orthogonal to one another to take advantage of the orthogonal electric fields in a dual mode for example.

Preferably, said metal member comprises a plate or plate-like shape. The metal member may comprise, or consist of, a metal.

Advantageously, there are two dielectric resonator elements providing a two pole filter. In one embodiment each dielectric resonator element resonates in a single mode.

In another embodiment there are three, four, etc., dielectric resonator elements each operable in a dual mode to provide a six-, eight- or more pole filter.

Preferably, the filter is configured such that the lowest resonant frequency is provided by a Hybrid Electric and/or Magnetic mode. In one embodiment the HEM₁₁ mode is preferred as spurious frequencies (i.e. resonant frequencies of other modes) are much higher and therefore the filter has a better response characteristic.

According to another aspect of the present invention there is provided a filter comprising a plurality of filters as set out above, which filter comprises a body defining a plurality of cavities linked so as to provide coupling between a dielectric resonator element in each cavity and a path for a microwave signal through said filter.

Advantageously, the coupling between said cavities is provided by an iris formed in the conductive wall therebetween, the size of said iris controllable by a tuning screw.

Preferably, said metal members are independently controllable for example by different voltages supplied from a power source.

According to another aspect of the present invention there is provided an electronic device comprising a filter as aforesaid.

According to another aspect of the present invention there is provided a method of filtering different frequency bands from an input frequency spectrum using a dielectric resonator filter as aforesaid, which method comprises the steps of:
(a) filtering a first frequency band from said input frequency spectrum;
(b) adjusting said dielectric resonator filter by actuating said deformable element to move said metal member toward and/or away from said dielectric resonator element to effect adjustment of a said first frequency band to a second frequency band; and
(c) filtering said second frequency band from said input frequency spectrum.

Advantageously, step (b) is carried out by transmitting an adjustment signal to said filter from a location remote therefrom.

According to yet another aspect of the present invention there is provided a method of tuning a dielectric resonator filter as aforesaid, which method comprises the steps of:
(a) passing a signal through said filter;
(b) adjusting a perturbing member on said filter to perturb the electromagnetic fields within at least one cavity in said filter, whereby a bandwidth of said filter and a coupling between at least two degenerate modes in said filter may be adjusted simultaneously; and
(c) if necessary, repeating step (b) until desired filter characteristics are substantially met.

According to yet another aspect of the present invention there is provided a piezoelectrically tunable microwave filter based on one or more dielectric resonators in which the fundamental resonant frequency is the dual generated HEM₁₁ mode.

Preferably, tuning is provided by a piezoelectric unit placed outside a resonator cavity of said filter.

For a better understanding of the present invention, reference will now be made by way of example to the accompanying drawings, in which:

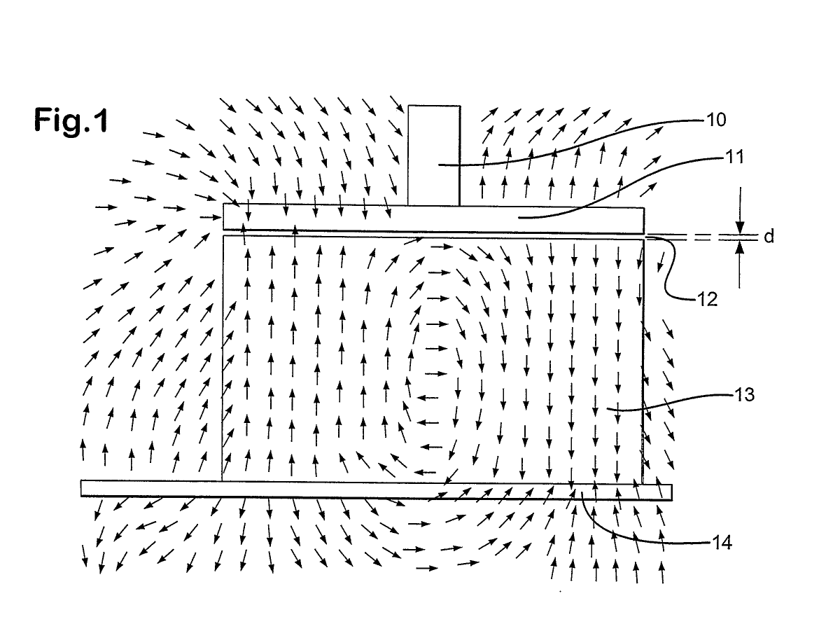

FIG. 1 shows the distribution of the electric field HEM₁₁ simulated using Ansoft HFSS v. 8.0;

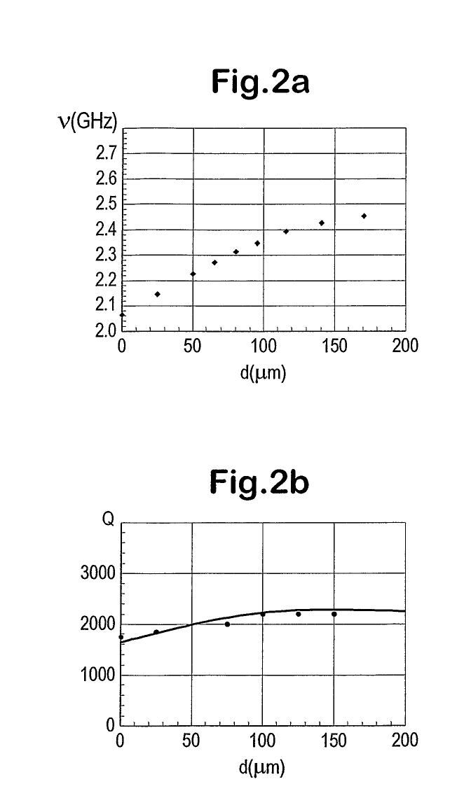

FIG. 2a is a graph of the resonance frequency (y-axis) of the dielectric resonator in FIG. 1 versus gap size (d) (x-axis);

FIG. 2b is a graph of quality factor of the dielectric resonator (y-axis) in FIG. 1, versus gap size (d) (x-axis);

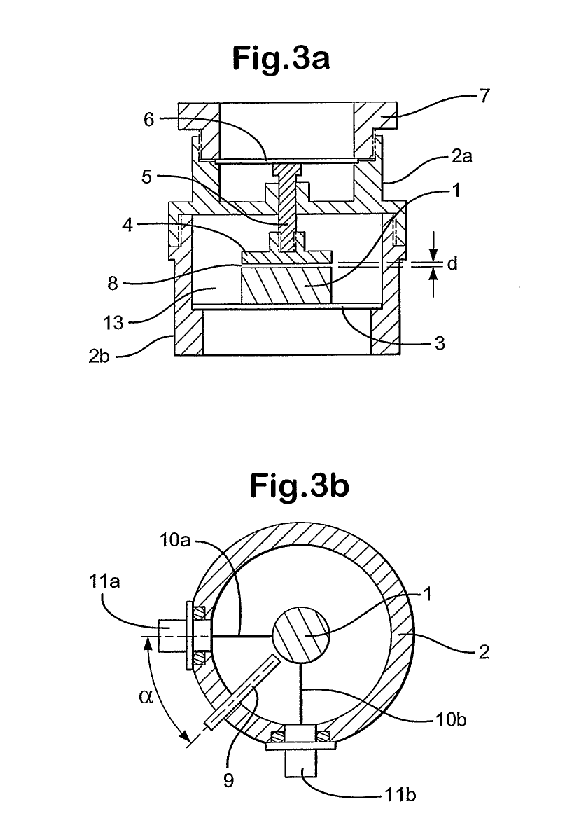

FIG. 3a is a schematic side cross section of a first embodiment of a filter according to the present invention;

FIG. 3b is a plan view of the filter of FIG. 3a;

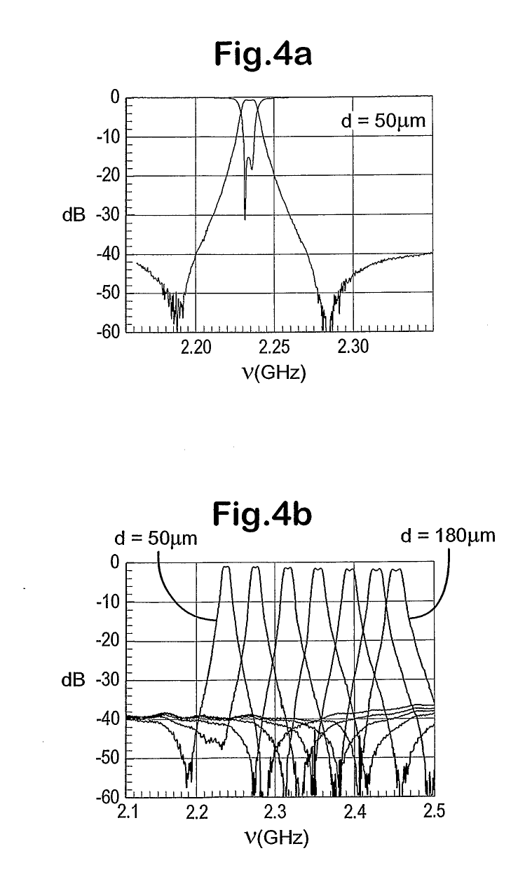

FIG. 4a is a graph of the frequency response (y-axis) versus frequency (x-axis) for the filter of FIGS. 3a and 3b;

FIG. 4b is a graph of the frequency response (y-axis) versus frequency (x-axis) for the filter of FIGS. 3a and 3b showing how the pass band can be shifted;

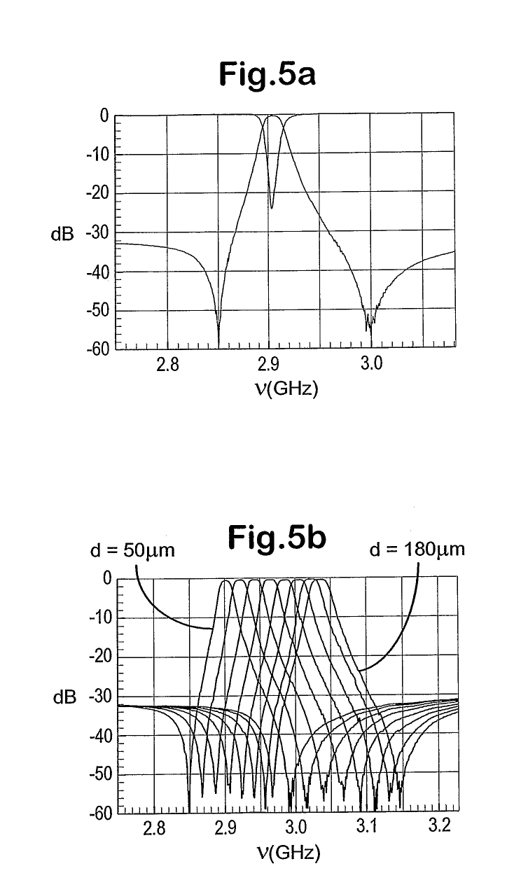

FIG. 5a is a graph of the frequency response (y-axis) versus frequency (x-axis) for the filter of FIGS. 3a and 3b (with a puck made from different dielectric material);

FIG. 5b is a graph of the frequency response (y-axis) versus frequency (x-axis) for the filter in FIG. 5a showing how the pass band can be shifted;

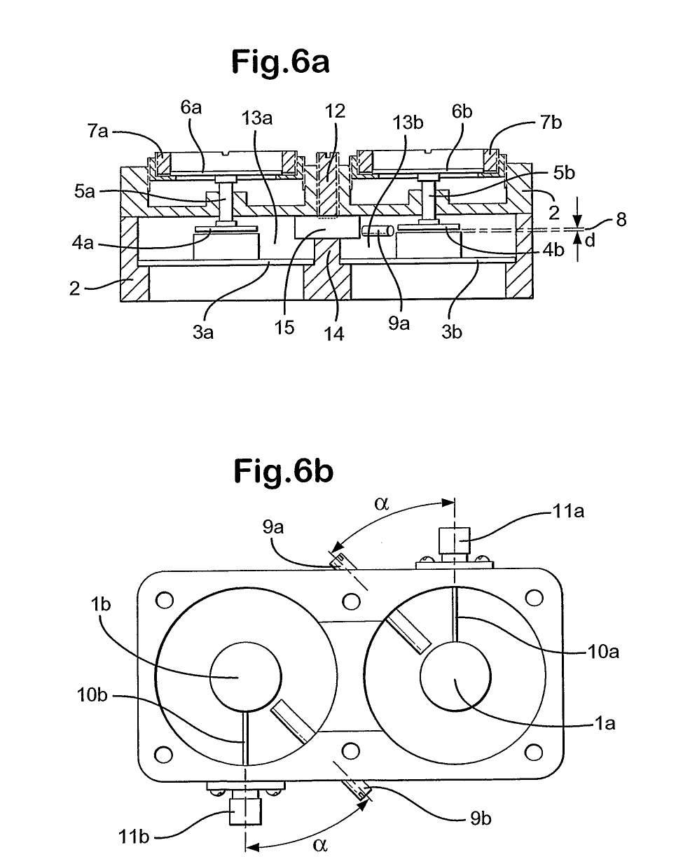

FIG. 6a is schematic side cross section of a second embodiment of a filter according to the present invention;

FIG. 6b is a plan view of the filter of FIG. 6a;

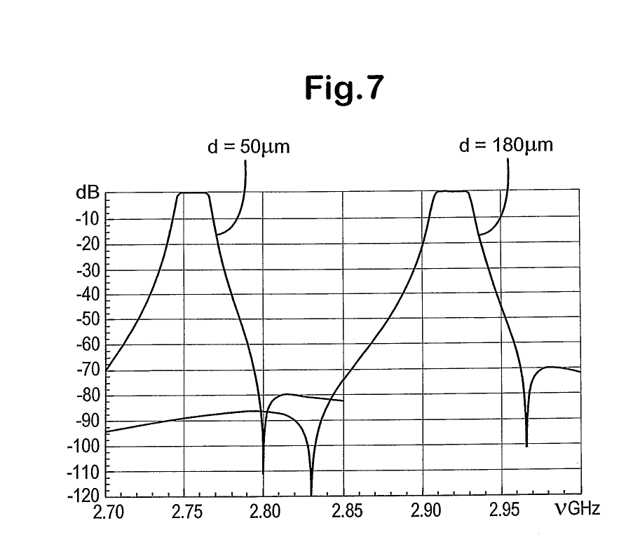

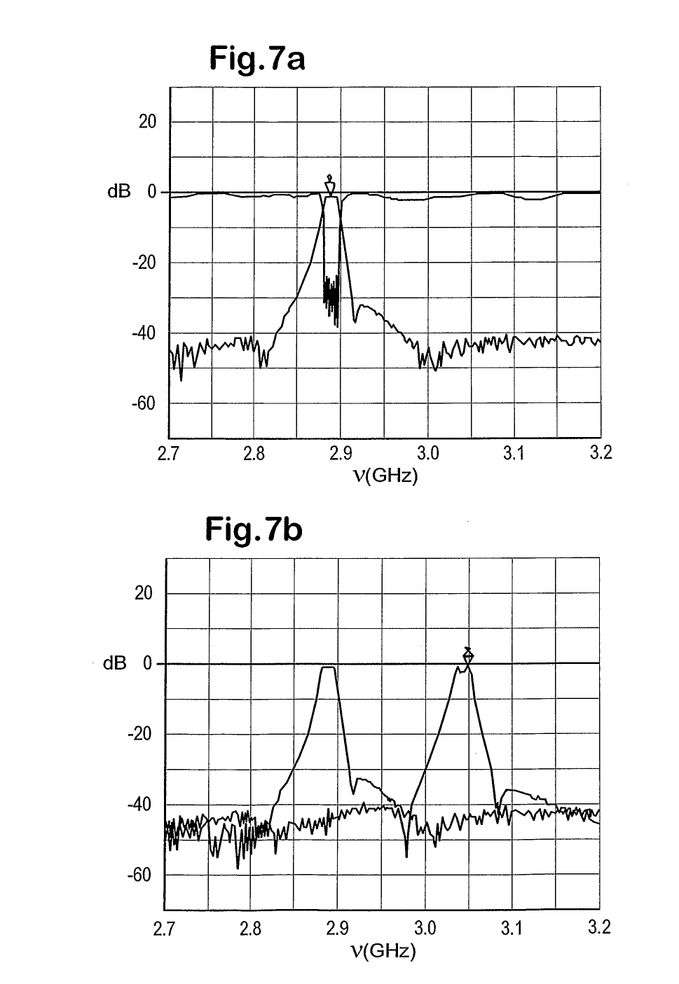

FIG. 7a a graph of the frequency response (y-axis) versus frequency (x-axis) for the filter of FIGS. 6a and 6b;

FIG. 7b is a graph of the frequency response (y-axis) versus frequency (x-axis) for the filter in FIGS. 6a and 6b showing how the pass band can be shifted; and

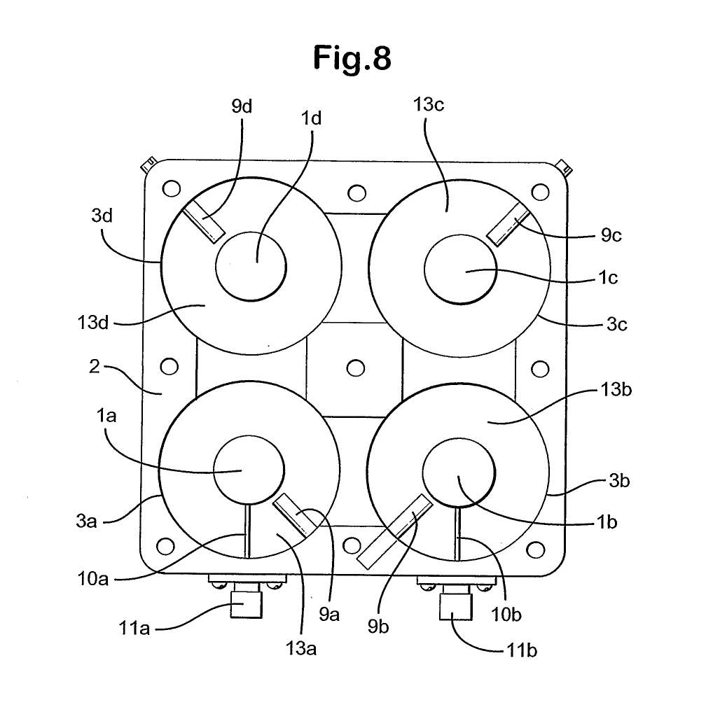

FIG. 8 is a schematic plan view of a third embodiment of a filter according to of the present invention.

Referring to FIG. 1 a computer simulation of the distribution of the electric field of a dielectric resonator filter tuned to operate in the HEM₁₁ mode is shown. The filter comprises a resonator cavity (not shown) having a grounded metal substrate (14) on which is supported a cylindrical dielectric resonator DR element (13). A metal member in the form of a disc (11) is disposed adjacent the DR 13 with an air gap d (12) therebetween. The metal disc is also cylindrical in shape and has a diameter of 14 mm (similar to the diameter of the puck (1)) and a thickness of 1 mm. The metal disc (11) is mounted on a brass rod (10) co-axially with the longitudinal axis of the DR 13 permitting the metal disc (11) to move axially toward and away from the upper surface of the DR 13. The rod (10) may be constructed of other materials e.g. plastics, ceramic, but preferably from a material with a low thermal expansion coefficient e.g. invar. The simulation was performed using Ansoft HFSS v 8.0. The swirling part of the electric field near the centre of the DR 13 is weaker than the electric field that is oriented substantially parallel to the longitudinal axis of the DR 13.

Referring to FIG. 3a, a tunable or re-configurable two-pole DR filter according to the first embodiment of the present invention is shown. A cylindrical chamber (2) is defined by an electrically conductive material, in this case silver plated aluminium, comprising a base or housing (2b) and a cover (2a) which are in electrical contact with one another. The cover (2a) fits over the base in a similar fashion to a lid; in an alternative embodiment the base (2b) and cover (2a) may comprise flat surfaces for abutment with one another and held together by bolts. The base (2b) comprises a bore passing from one side of the base to the other. A ledge is provided partway along the length of the bore that supports a dielectric substrate (3) made from a low loss dielectric, in this case aluminium oxide. The dielectric substrate (3) comprises a metal-coated lower surface that contacts the ledge; the dielectric substrate can be about 0.5-2.0 mm thick and the metal-coated lower surface is about 6 μm thick comprising a 4 μm thick base layer of copper covered with a 2 μm thick covering layer of gold to inhibit oxidisation of the copper. An upper surface of the dielectric substrate (3) supports a dielectric resonator element or puck (1) that is of cylindrical shape. The base (2b), cover (2a) and dielectric substrate (3) define a cylindrical cavity (13). The top and bottom covers (2a) and (2b) are separable to enable manufacture of the filter.

The cover (2a) comprises an upwardly projecting annular support provided with a ledge on its inner surface. In the centre of the cover (2a) an aperture accommodates an arm which in this case is a metal rod (5) (that in this embodiment is made from brass, but could be any of the materials mentioned in connection with the metal rod (10) above) for sliding movement along its longitudinal axis. A lower end of the metal rod (5) is disposed within the cavity (13) and mounts a metal member in this embodiment metal tuning disc (4) adjacent and substantially co-axial with the longitudinal axis of the puck (1). The metal tuning disc (4) is made from copper in the shape of a flattened cylinder of 14 mm diameter by 1 mm thick. The diameter of the metal tuning disc (4) is substantially the same as the diameter of the puck (1), although this is not essential. The lower surface of the metal tuning disc (4) (which is substantially flat) is held by the metal rod (5) at a distance d and substantially parallel with an upper surface of the puck (1) (which is also substantially flat).

An upper end of the metal rod (5) is disposed outside the cavity (13) and is connected to the centre of a deformable element in this embodiment a circular piezoelectric actuator (6). In this embodiment the actuator (6) was soldered to the cover (2a), but it might be glued or fixed in any other way that provides a firm connection to the cover (2a). The actuator (6) has a diameter of 25 mm and rests on the ledge in the upwardly projecting annular support of the cover (2a); it is confined to the ledge by a top cap (7), made of plastics i.e. a non-conducting material, that screws into the upwardly projecting annular support and holds the actuator (6) on the ledge.

The piezoelectric actuator (6) is a circular bimorph plate defined by two piezoelectric plates cemented together in such a way that an applied voltage causes one to expand and the other to contract. Suitable circular bimorph plates can be obtained from Morgan Electroceramics, USA. Thus, the bimorph plate bends in proportion to the applied voltage. The actuator (6) is connected to an external variable power source which can provide a DC voltage from zero Volts to several hundreds of Volts. When a voltage is applied, the piezoelectric actuator (6) bends accordingly (restrained in the upward sense by top cap (7)) and moves the metal rod (5) and metal tuning disc (4) either towards or away from the puck (1), thereby changing the air gap d therebetween, and as explained below, the frequency band of the filter.

Referring also to FIG. 3b there is an input connector (11a) which is coupled with the puck (1) by an input microstrip line (10a) formed onto the top side of the dielectric substrate (3). The microstrip line runs from the input connector (11a) to the dielectric resonator element (1). For coupling the resonant energy out of the filter, there is output microstrip line (10b), formed on the top side of the dielectric substrate (3), orthogonal to the input microstrip line (10a). The output microstrip line (10b) runs from the dielectric resonator element (1) to the output connector (11b).

The fundamental mode of the filter in FIGS. 3a and 3b is the dual generated HEM₁₁ mode i.e. where there are two degenerate modes and therefore two resonant frequencies available to obtain a filter function. To control the dielectric resonator dual mode degeneration and therefore the electrical characteristics of the filter, the applicant has realized that only one perturbing member (in this embodiment an adjustable screw (9)) is needed to perform both a tuning and a coupling function. In particular, the adjustable screw (9) is positioned so that its axis lies in the cavity (13) where at each point the amplitude of the electrical field of each degenerate mode is expected to be the same or substantially the same. This may be determined having regard to the electric field patterns of the modes excited in the cavity (13). When so positioned the adjustable screw (9) is able to perform the two functions: firstly it serves to tune the bandwidth of the filter by moving the resonant peaks of the two degenerate modes either together or apart; secondly it serves to couple the energy between the two degenerate modes. If the axis of adjustable screw (9) is not in this position, the tuning and coupling function is still provided, albeit to a lesser degree. Furthermore, the intensities of the two resonant frequencies are then different to one another resulting in less desirable filter characteristics. In FIG. 3b the axes where the amplitude of electrical field strength of each mode is the same are, measured relative to the input microstrip line 10a, about α=45°, 135°, 225° and 315°. However, it is important that the adjustable screw (9) is positioned to maintain symmetry between the input microstrip (10a) and output microstrip (10b); otherwise the perturbation it provides on the electromagnetic fields will have an asymmetric effect on each degenerate mode. Accordingly the best positions for the adjustable screw (9) with one dielectric resonator element (1) as shown in FIG. 3b is at 45° or 225° measured with respect to the line defined by the longitudinal axis of the microstrip 10a.

The applicant has further found that these two screw positions provide different types of filter function. In particular, when placed at 45° (as shown in FIG. 3b) the adjustable screw (9) provides an elliptic filter characteristic, whereas at the 215° position it provides a Chebyshev filter function. It is believed that this is due to different amounts of energy coupled between the input (11a) and output (11b) in the two positions: in the 45° position more energy is coupled between the input and the output by the adjustable screw (9) than in the 215° position. The elliptic characteristic of the filter response is shown in FIG. 4 and FIG. 5.

As part of the manufacturing process the adjustable screw (9) may be turned so as to move into or out of the cavity to set the bandwidth (i.e. the frequency between the resonant peak of each degenerate mode) of the filter for the intended application. Once set, the adjustable screw (9) does not need to be adjusted again.

Referring to FIGS. 6a and 6b, a tunable or re-configurable four-pole DR filter according to the second embodiment of the present invention is shown. The filter uses two dielectric resonators arranged so as to operate in the dual mode HEM₁₁. The construction of each DR is generally similar to the embodiment shown in FIGS. 3a and 3b. However, the energy must be coupled from DR to the other if the four pole filter is to work.

A body (2) made of an electrically conductive material in this embodiment aluminium comprises a base and a cover which are in electrical contact with one another. Two bores inside the base are partially separated by a conductive wall (14) to two define cylindrical cavities (13a and 13b respectively). A dielectric resonator element or puck (1a and 1b) is located in each cavity (13a) and (13b) supported by dielectric substrates (3a and 3b). In use, the coupling between dielectric resonator elements is provided by an iris (15) formed in the conductive wall (14); the coupling can be adjusted by a tuning screw (12) that is disposed to move up and down with respect to the conductive wall (14) to change the size of the iris (15). A metal member that in this embodiment is a metal tuning disc (4a and 4b) is suspended above the dielectric resonators (1a and 1b) at a distance d (8) respectively. Similar to FIG. 3a a metal rod (5a and 5b) connects each metal tuning disc (4a and 4b) to a circular piezoelectric actuators (6a and 6b) which are placed outside cavities (13a and 13b). The actuators (6a and 6b) are held in place by a respective top cap (7a and 7b) to the top cover of the chamber (2). Each top cap (7a and 7b) comprises a non-conductive material, in this embodiment PTFE.

Each deformable element that in this embodiment is a piezoelectric actuator (6a and 6b) is a circular bimorph cell defined by two piezoelectric plates cemented together in such a way that an applied voltage causes one plate to expand and the other to contract. Thus, each bimorph cell bends in proportion to the applied voltage. Each actuator (6a and 6b) is connected to a separate external variable power source which can provide a DC voltage from zero Volts to several hundreds of Volts. When a voltage is applied, each piezoelectric actuator (6a and 6b) bends accordingly and moves the respective metal rod (5a and 5b) and metal tuning disc (4a and 4b) either towards or away from the respective puck, thereby changing the air gap d therebetween. Since no two cavities, dielectric resonator elements, etc. are the same it is expected that the air gap d may need to be adjusted to a different initial setting for each dielectric resonator element to obtain the required electrical characteristics of the filter. This may be accomplished at point of manufacture for example. Furthermore, each actuator (6a and 6b) may respond differently to the same applied voltage. Accordingly it may be necessary to calibrate the actuators at point of manufacture by determining how much movement is achieved for a given applied voltage. When re-configuring the filter during in use it may then be necessary to apply a different voltage to each actuator (6) to obtain the same amount of movement of each metal tuning disk (4a and 4b) so that the electrical characteristics of the filter are substantially unaffected.

A signal is applied into the filter from an input connector (11a) that is coupled with the first dielectric resonator by an input microstrip line (10a) formed onto the top side of the dielectric substrate (3a). The microstrip line (10a) runs from the input connector to the first dielectric resonator (1a). The first resonator (1a) is coupled with the second/output resonator (1b) by an iris (15) formed in the conductive wall (14). The coupling between cavities is controlled by tuning screw (12). For coupling the resonant energy out of the filter, there is output microstrip line (10b), formed on the top side of the substrate (3b), and turned by 180° to the input microstrip line (10a) The output microstrip line (10b) runs from the second/output dielectric resonator (1b) to the output connector (11b) which is positioned on the opposite (in respect to the input connector) wall.

In use, the fundamental mode of both dielectric resonators is the dual generated HEM₁₁ mode i.e. where there are two degenerate modes and therefore two resonant frequencies available to obtain a filter function. To control the dielectric resonator dual mode degeneration, only one perturbing member, which in this embodiment is an adjustable screw (9a and 9b), per dielectric resonator is used. The adjustable screws (9a and 9b) are positioned in the same manner as described above for FIGS. 3a and 3b i.e. at an angle α=45° in respect to the input and output connectors, respectively. As the electric fields of the degenerate modes are orthogonal to one another it is important to place the input (11a) and output (11b) in the same way. In this case the input to dielectric resonator element 1a is the microstrip 10a and a “virtual” output is provided by the iris (15); the axis of the iris (15) lies substantially perpendicular to the axis of the microstrip (10a). The output (11b) lies perpendicular to the virtual input provided by the iris (15), although it could have been placed 180° from the position shown in FIG. 6b. As described above only one perturbing member, in this embodiment an adjustable screw (9a and 9b), is required per dielectric resonator element to set the filter bandwidth and the degree of coupling between the degenerate modes.

The adjustable screws also provide feedback between the input/output loops, which results in elliptic characteristics of the filter response as presented in FIG. 7. The adjustable screws (9a and 9b) may also be placed at an angle of α=225° if a Chebyshev filter response is desired. In this embodiment the input (11a) and output (11b) may be located on the same side of the body (2), although for easy access to the adjustable screws (9a and 9b) the arrangement shown in FIG. 6b is preferred.

FIG. 8 shows a tunable or re-configurable eight-pole filter based on four dielectric resonator elements according to a further embodiment of the present invention. The filter uses two dielectric resonator elements arranged so as to operate in the dual mode HEM₁₁. The construction of each DR is generally similar to the embodiment shown in FIGS. 3a, 3b, 6a and 6b. However, the energy must be coupled from one DR to the next if the four pole filter is to work. This embodiment presents a possible arrangement of dielectric resonators to form an eight pole filter using the principle of the invention. In particular, the arrangement of the input, outputs and perturbing members (e.g. adjustable screw) of each dielectric resonator element follows that discussed above.

In the Figure, four dielectric resonators (1a-1d) are each supported in a body (2) by a respective dielectric substrate (3a-3d). The filter comprises a base and a cover, both made of an electrically conductive material, and both of which are in electrical contact with one another. Four bores inside the base are divided by conductive walls to form four cylindrical cavities (13a-13d). The coupling between dielectric resonator elements is provided by irises formed in the conductive walls. Four metal tuning discs are adjustable by a respective deformable element, in this embodiment each comprising a piezoelectric actuator, and each metal disc is suspended above a respective dielectric resonator element at a distance d. The piezoelectric actuators are used to tune or re-configure the filter frequency band. Each piezoelectric unit may be controlled separately. As described above in connection with FIGS. 6a and 6b each piezoelectric actuator may need to be controlled with a different voltage to obtain the same degree of movement of all of the metal tuning disks when re-configuring the filter.

A signal is applied into the filter from an input connector (11a) and coupled with the dielectric resonator by an input microstrip line (10a) formed onto the top side of the dielectric substrate (3a). The microstrip line runs from the input connector to the first dielectric resonator (1a) (bottom left FIG. 8). The first dielectric resonator (1a) is coupled with the second (1b) (top left FIG. 8), the second is coupled to the third (1c) (top right FIG. 8); the third is coupled to the fourth resonator (1d) (bottom right FIG. 8); and the fourth is coupled back to the first; by irises formed in the conductive walls. For coupling the resonant energy out of the filter, there is output microstrip line (10b), formed on the top side of the substrate (3b), and parallel to the input microstrip line (10a). The output microstrip line (10b) runs from the fourth dielectric resonator (1d) to the output connector (11b) which is parallel to the input connector.

The fundamental mode of all dielectric resonators is the dual generated HEM₁₁ mode. To control the dielectric resonator dual mode degeneration, only one adjustable screw per dielectric resonator is needed. To provide elliptic characteristics of the filter response, the adjustable screws (9a-9d) are located at angles α=(n·90°+45°), (where n=0 or 1) with reference to the input/output connector plane, respectively. When the adjustable screws are located at angle α=(n·90°+45°), (where n=2 or 3), the filter has Chebyshev type response.

The invention is further described in the examples.

### EXAMPLE 1

A filter according to FIGS. 3a and 3b was set up in which a puck (1) made of a Ba—La—Ti—O ceramic (dielectric constant ∈=80, unloaded Q-factor ˜3000 at 3 GHz and temperature coefficient of the resonance frequency τf=+3.0 ppm/K, diameter=14.2 mm, height=7.2 mm.) was placed on the dielectric substrate (3) made of aluminium oxide, on which the lower side was coated with a layer of alumina that can be between about 0.5 mm and 2.0 mm thick. The cavity (13) had a diameter 35 mm and height 20 mm and was silver-plated. A metal tuning disc (4) with a diameter substantially equal to the diameter of the puck (1) was suspended over the puck with a small gap d. A circular piezoelectric bimorph (6) with diameter 25 mm and thickness 1 mm was used for driving the metal disk along axis of the puck (1). The downward displacement at the centre of the bimorph was ˜140 μm under 300V bias voltage.

A signal of between 1 and 10 W power was used to test the filter. The filter performance did not change noticeably between different input powers. Coupling between the input and output ports and the puck (1) was maintained by microstrip lines patterned on the top side of the dielectric substrate (3). The coupling between the puck (1) and the microstrip lines was achieved by placing the puck (1) in close proximity to the microstrip line. For example the puck (1) may be placed next to the microstrip line or even on top of the microstrip line. In this example, the puck was placed such that approximately 1 mm of the end of the microstrip lines were underneath the puck (1) providing the coupling of the resonator with input and output ports. In use the fundamental resonance mode with the lowest frequency was the dual degenerate mode HEM₁₁. The internal coupling between the pair of resonator modes was facilitated by the adjustable screw positioned at an angle 45° of the input connector. The coupling between modes was defined by the distance between the circumference of the resonator and the screw face; this distance must be determined for every filter by adjusting the screw until the desired filter response is seen e.g. on a network analyser. It was observed that the first spurious mode of the resonator was at ˜1 GHz higher than the frequency of the fundamental mode (2.06 GHz).

The distribution of the electric field HEM₁₁ is shown in FIG. 1. The dependencies of the resonance frequency and quality factor of the dielectric resonator with HEM₁₁ mode on the gap between the top flat surface of the puck (1) and metal tuning disc (4) are shown in FIGS. 2a and 2b. Referring to FIG. 2a it will be noted that changing the distance between the lower surface of metal tuning disc (4) and the upper surface of the puck (1) only a very small amount i.e. between 0 μm and about 170 μm effected a change in the centre frequency of the filter from about 2.06 GHz to 2.46 GHz i.e. providing a re-configuration range of 400 MHz at 2 GHz. It was very surprising that tuning could be performed over such a wide frequency range for such a small amount of movement of the metal tuning disc (4). Referring to FIG. 2b it is also seen that for approximately the same range of d the Q factor of the filter changes only from about 1700 to 2200.

Referring to FIGS. 4a and 4b, the experimentally measured insertion and return losses of the filter in Example 1 as well as the re-configuration of the centre frequency are presented as a function of the gap d between the top surface of the puck (1) and the metal tuning disc (4). In FIG. 4b the filter had a centre frequency of f_{c}=2.24 GHz at d=50 μm. The bandwidth (Δf/f) for 1 dB below centre frequency level was ˜0.5% i.e. 0.0112 GHz. Applying a dc bias up to 300V to the piezoelectric actuator (6) resulted in altering of the distance between top surface of the resonator and metal disc from 50 μm to 180 μm, and shifted the centre frequency of the filter to about 2.45 GHz and a central frequency tuning (ΔF/f) of ˜10% was achieved. The insertion losses in the whole tuning range were below ˜−1 dB, while the return loss at the centre frequency was less than −15 dB which is very surprising given the tuning range of filter. The measured characteristics are shown in FIG. 4a.

### EXAMPLE 2

The filter as in Example 1 was repeated except that the puck (1) was made of a Ba—Zn—Ta—O ceramic (∈=30, Q×f product 100,000 GHz). The filter was modeled, and the theoretical results as follows: the filter centre frequency was f_{c}=2.90 GHz. The bandwidth (Δf/f) for 1 dB level was ˜0.3%. Applying a dc bias up to 300V to the piezoelectric actuator (6) resulted in altering of the distance between top surface of the puck and metal tuning disc from about 50 μm to 180 μm, a central frequency tuning (ΔF/f) of ˜8% was achieved as shown in FIG. 5b. As shown in FIG. 5a the insertion losses in the whole tuning range were below ˜−0.5 dB, while the return losses were less than −20 dB.

The filter was then constructed and tested. A signal of between 1 and 10 W power was used to test the filter. The filter performance did not change noticeably between different input powers. FIGS. 7a and 7b show the experimental results: the filter demonstrates a center frequency of f_{c}=2.90 GHz that is re-configurable to about 3.04 GHz. The insertion loss over the re-configuration range is less than 1.4 dB, bandwidth of Δf/f_{c}=(0.3−0.5) % and the frequency tunability of ΔF/f_{c}˜140 MHz (tuning is more than 10 bands of filter). The return losses are less than −15 dB.

A filter employing the present invention has wide application, for example: military/commercial radars, cellular base stations, satellite communication systems, automotive anti-collision radars, frequency selective surfaces, etc.

Any suitable dielectric material may be used to form the dielectric resonator element, for example Ba—Mg—Ta—O and Ca—Ti—Nd—Al—O. The dielectric resonator element may be made in any shape that substantially matches the shape of the cavity (or vice versa) in which it is to be used, for example: cuboid, spherical, hemi-spherical or cruciform. For example in a cuboid embodiment there may be three degenerate resonant frequencies present. These may be coupled and adjusted in a similar way to that described above, except that more than one surface of the cuboid will need to have an adjacent metal member to provide the re-configuration function. The dielectric resonator element may be substantially any size, although the size will depend on the relative dielectric constant of the material and the desired frequency of operation.

For good performance the distance between the outer surfaces of the dielectric resonator element and the cavity walls should be such that the wall losses introduced are kept as low as is feasible. This distance is usually at least approximately the diameter of the dielectric resonator element (assuming it is circular in plan view), but can be greater. However, this distance can be less than the diameter of the dielectric resonator element if a more compact design is sought. The cavity may also be any shape that substantially matches that of the dielectric resonator element.

The invention can also employ either the HEM₁₂ or HEM₂₁ mode, although other hybrid modes are not excluded. However, when a higher order mode is used, other resonant modes (known as spurious frequencies) are closer to the resonant frequencies of interest. This can have a detrimental effect on the filter function.

The deformable element may comprise any device is able to effect a controlled movement of the arm. For example, the deformable element may comprise piezo-mechanical material, a micro electro-mechanical system (MEMS), a magnetostrictive material or a bi-metallic strip

The metal member may comprise any suitable metal, for example copper, brass or aluminium. It is preferable if the surface is plated (e.g. with silver or gold), and/or is polished. The shape of the metal member (e.g. in plan view) should substantially match the side of the dielectric resonator element to which it will be brought adjacent; it is not necessary however for the metal member to be the same size (e.g. diameter) as the dielectric resonator element. It may be smaller, larger or the same size. It has been found however that a size of metal member ±10% of the size of the surface of the dielectric resonator element produces good results. The thickness of the metal member should be sufficient to hold the desired shape, and may be between about 2 mm and 4 mm for example.

1. A dielectric resonator filter having at least two poles for filtering a frequency band from an input frequency spectrum, which filter comprises (i) a body formed of electrically conductive material, which body defines a cavity therein; (ii) a dielectric resonator element enclosed in said cavity, (iii) a deformable member located outside said cavity, and (iv) a metal member located within said cavity that is connected to said deformable member, the arrangement being such that, in use, said deformable member is deformable to move said metal member toward and/or away from said dielectric resonator element to effect adjustment of said frequency band.

2. A filter as claimed in claim 1, wherein movement of said deformable member effects a shift of said frequency band from a lower to a higher frequency band, or vice versa.

3. A filter as claimed in claim 1 or 2, wherein one or more filter characteristic of said filter remains substantially unaffected by said adjustment.

4. A filter as claimed claim 1, 2 or 3, wherein said cavity, in which resonance takes place, has the same dimensions following said adjustment.

5. A filter as claimed in any of claims 1 to 4, wherein said deformable element is deformable in response to a signal, whereby said adjustment may be made remotely from said filter.

6. A filter as claimed in any preceding claim, wherein in use said deformable element is able to effect an overall movement of said metal member from a point about 200 μm away from said dielectric resonator element to a point substantially in abutment with part of said dielectric resonator element.

7. A filter as claimed in any preceding claim, wherein said deformable element is deformable upon application of a voltage.

8. A filter as claimed in any preceding claim, wherein said deformable member is connected to said metal member via an arm, which arm is slidable in use through an aperture in said body.

9. A filter as claimed in any preceding claim, wherein said deformable member comprises a piezoelectric bimorph.

10. A filter as claimed in claim 9, wherein said piezoelectric bimorph is held substantially fixed relative to said body by a top cap.

11. A filter as claimed in any preceding claim, configured such that in use, said at least two poles are provided by a dual mode in which at least two degenerate resonant frequencies are supported on one dielectric resonator element.

12. A filter as claimed in claim 11, further comprising a perturbing member that is moveable into an out of said cavity for simultaneously adjusting the energy coupled between said at least two degenerate resonant frequencies and the spacing between the resonant frequencies thereof.

13. A filter as claimed in claim 12, wherein said perturbing member is positioned in a part of said cavity in which at each point the amplitude of the respective electric field due to said at least two degenerate modes is substantially the same.

14. A filter as claimed in claim 12 or 13, wherein there is only one perturbing member per dielectric resonator element.

15. A filter as claimed in claim 12, 13 or 14, wherein said perturbing member is located substantially at an angles α=(n·90°+45°) where n=0, 1, 2, 3 in reference of the input connector plane.

16. A filter as claimed in claim 15, wherein said perturbing member is located at an angle α=(n·90°+45°) where n=0 or 1 to provide an elliptic response of said filter.

17. A filter as claimed in claim 15, wherein said perturbing member is located at an angle α=(n·90°+45°), (where n=2 or 3) to provide a Chebyshev response of said filter.

18. A filter as claimed in any of claims 12 to 17, wherein said perturbing member is positioned to substantially maintain symmetry in plan view between an input and an output to said dielectric resonator element.

19. A filter as claimed in any of claims 12 to 18, wherein said perturbing member comprises an adjustable screw.

20. A filter as claimed in any preceding claim, further comprising a dielectric substrate defining a lower limit of said cavity.

21. A filter as claimed in claim 20, wherein said dielectric substrate comprises a metallized side and a dielectric side, said dielectric resonator element supported on said dielectric side

22. A filter as claimed in any preceding claim, further comprising a pair of microstrip lines providing an input and an output to said filter.

23. A filter as claimed in claim 22, wherein said pair of microstrip lines is substantially orthogonal to one another.

24. A filter as claimed in any preceding claim, wherein said metal member comprises a plate.

25. A filter as claimed in any of claims 1 to 10, wherein there are two dielectric resonator elements providing a two pole filter.

26. A filter as claimed in of claims 1 to 10, wherein there are three, four, etc., dielectric resonator elements each operable in a dual mode to provide a six-, eight- or more pole filter.

27. A filter as claimed in any preceding claim, configured such that the lowest resonant frequency is provided by a Hybrid Electric and/or Magnetic mode.

28. A filter as claimed in claim 27, configured to operate in the HEM₁₁ mode.

29. A filter comprising a plurality of filters as claimed in any preceding claim, which filter comprises a body defining a plurality of cavities linked so as to provide coupling between a dielectric resonator element in each cavity and a path for a microwave signal through said filter.

30. A filter as claimed in claim 29, wherein in which the coupling between said cavities is provided by an iris formed in the conductive wall therebetween, the size of said iris controllable by a tuning screw.

31. A filter as claimed in claim 29 or 30, wherein said metal members are independently controllable.

32. An electronic device comprising a filter as claimed in any of claims 1 to 31.

33. A method of filtering different frequency bands from an input frequency spectrum using a dielectric resonator filter as claimed in any of claims 1 to 31, which method comprises the steps of:
(a) filtering a first frequency band from said input frequency spectrum;
(b) adjusting said dielectric resonator filter by actuating said deformable element to move said metal member toward and/or away from said dielectric resonator element to effect adjustment of a said first frequency band to a second frequency band; and
(c) filtering said second frequency band from said input frequency spectrum.

34. A method as claimed in claim 31, wherein step (b) is carried out by transmitting an adjustment signal to said filter from a location remote therefrom.

35. A method of tuning a dielectric resonator filter as claimed in any of claims 1 to 31, which method comprises the steps of:
(a) passing a signal through said filter;
(b) adjusting a perturbing member on said filter to perturb the electromagnetic fields within at least one cavity in said filter, whereby a bandwidth of said filter and a coupling between at least two degenerate modes in said filter may be adjusted simultaneously; and
(c) if necessary, repeating step (b) until desired filter characteristics are substantially met.

36. A dielectric resonator filter having at least two poles for filtering a frequency band from an input frequency spectrum, which filter comprises (i) a body formed of electrically conductive material, which body defines a cavity therein; (ii) a dielectric resonator element enclosed in said cavity, and (iii) a perturbing member, the arrangement being such that, in use, said dielectric resonator element resonates in a dual mode in which there are at least two modes having a respective degenerate resonant frequency, and said perturbing member is moveable into and out of said cavity so as to adjust simultaneously the spacing between said at least two degenerate resonant frequencies and the coupling of energy between said at least two modes.

37. A piezoelectrically tunable microwave filter based on one or more dielectric resonators in which the fundamental resonant frequency is the dual generated HEM₁₁ mode.

38. A piezoelectrically tunable microwave filter as claimed in claim 37, wherein tuning is provided by a piezoelectric unit placed outside a resonator cavity of said filter.
